(19) United States
(12) Patent Application Publication
(10) Pub. No.: US 2012/0065318 A1
(43) Pub. Date: Mar. 15, 2012

(54) Polyester/Polycarbonate Alloy Resin Composition and Molded Product Using the Same

(75) Inventors: Jung-Eun PARK, Uiwang-si (KR); In-Sik SHIM, Uiwang-si (KR); Bang-Duk KIM, Uiwang-si (KR); Doo-Han HA, Uiwang-si (KR)

(73) Assignee: CHEIL INDUSTRIES INC., Gumi-si (KR)

(21) Appl. No.: 13/300,746

(22) Filed: Nov. 21, 2011

Related U.S. Application Data
(63) Continuation-in-part of application No. PCT/KR2009/007944, filed on Dec. 30, 2009.

(30) Foreign Application Priority Data
Jun. 12, 2009 (KR) 10-2009-0052502

(51) Int. Cl. C08L 69/00; C08L 67/02

(52) U.S. Cl. 524/508; 525/148; 525/67; 525/63

(57) ABSTRACT

A polyester/polycarbonate alloy resin composition that includes (A) a base resin including (A-1) a polyester resin and (A-2) a polycarbonate resin; (B) a copolymer of a vinyl cyanide compound and an aromatic vinyl compound; and (C) a modified acrylic-based polymer is provided.

### CROSS-REFERENCE TO RELATED APPLICATIONS

This application is a continuation-in-part of International Application No. PCT/KR2009/007944, filed on Dec. 30, 2009, pending, which designates the U.S., published as WO 2010/143796, and is incorporated herein by reference in its entirety. This application also claims priority to and the benefit of Korean Patent Application No. 10-2009-0052502 filed in the Korean Intellectual Property Office on Jun. 12, 2009, the entire disclosure of which is also incorporated herein by reference.

### FIELD OF THE INVENTION

This disclosure relates to a polyester/polycarbonate alloy resin composition and a molded product using the same.

### BACKGROUND

Polyester resins can have excellent mechanical properties, electrical properties, and chemical resistance, and excellent molding properties due to a rapid crystallization rate. Therefore, polyester resins have received attention as thermosetting resins suitable for injection molding and as substitutes for metal, and have been used in the automotive and electric and electronic industries. However, polyester resins typically have a glass transition temperature of 40 to 60° C., and thus can have a low thermal distortion temperature. Also, polyester resins typically have low impact resistance at room temperature and low temperatures. Accordingly, there has been research directed to polyester/polycarbonate alloys for applications requiring high impact resistance.

In order to improve impact resistance, an acrylonitrile-butadiene-styrene copolymer (ABS) can be added to a polyester/polycarbonate alloy resin. However, this can significantly reduce heat resistance and thus is not applicable for use in applications requiring high heat resistance, such as automotive materials.

Ethylene-propylene copolymers (EPR), ethylene-propylene-diene copolymers (EPDM), methylmethacrylate-butadiene-styrene copolymers (MBS), and the like can also improve impact resistance. However, these additives also require a compatibilizer. If a compatibilizer is not used, the phases of polyester and polycarbonate become unstable, which may lead to a high deviation in mechanical properties.

Introducing a functional group may improve compatibility, and cross-linking a terminal group of a polyester resin may improve impact resistance. Non-reacted functional groups, however, may remain, which can cause a color change and generate gas during injection molding. For example, when glycidyl methacrylate is used, the external appearance of an injection molded product turns milky-white and the glycidyl methacrylate cannot be used for applications which are not painted.

### SUMMARY

One embodiment provides a polyester/polycarbonate alloy resin composition that can provide excellent impact resistance, heat resistance, and external appearance of an injection molded product and thus may be used in products which are not painted.

Another embodiment provides a molded product made using the polyester/polycarbonate alloy resin composition.

According to one embodiment, a polyester/polycarbonate alloy resin composition includes (A) about 100 parts by weight of a base resin including (A-1) about 40 to about 95 wt % of a polyester resin; and (A-2) about 5 to about 60 wt % of a polycarbonate resin; (B) about 0.1 to about 20 parts by weight of a copolymer of a vinyl cyanide compound and an aromatic vinyl compound; and (C) about 0.1 to about 10 parts by weight of a modified acrylic-based polymer, wherein the amounts of (B) and (C) are each based on about 100 parts by weight of the base resin.

The base resin (A) may include about 60 to about 90 wt % of the polyester resin (A-1) and about 10 to about 40 wt % of the polycarbonate resin (A-2).

The polyester resin (A-1) may be polybutylene terephthalate or polyethylene terephthalate, and may have an intrinsic viscosity [η] of about 0.35 to about 1.5 dl/g.

The polycarbonate resin (A-2) may be prepared by reacting one or more diphenols with a compound such as phosgene, halogen formate, carbonate, and combinations thereof, and may have a weight average molecular weight of about 10,000 to about 200,000 g/mol.

The copolymer of a vinyl cyanide compound and an aromatic vinyl compound (B) may include about 1 to about 30 wt % of a repeating unit derived from the vinyl cyanide compound.

The modified acrylic-based polymer (C) may be a polymer of an aromatic acrylic-based compound, an alicyclic acrylic-based compound, or a combination thereof, and a compound that may be polymerized with the aromatic acrylic-based compound, the alicyclic acrylic-based compound, or the combination thereof. The modified acrylic-based polymer (C) may include the aromatic and/or alicyclic acrylic-based compound in an amount of about 20 to about 99.9 wt % based on the total amount of the modified acrylic-based polymer (C). The aromatic and/or alicyclic acrylic-based compound may be an acrylic-based compound including a substituent such as a phenyl group, a cyclohexyl group, an ethylphenoxy group, or a combination thereof.

In exemplary embodiments, the modified acrylic-based polymer (C) may be a polymer of methylmethacrylate and phenylmethacrylate.

In exemplary embodiments, the modified acrylic-based polymer (C) may have the same refractive index as the polycarbonate resin (A-2).

The polyester/polycarbonate alloy resin composition may further include (D) about 1 to about 30 parts by weight of an impact-reinforcing agent, based on about 100 parts by weight of the base resin.

The impact-reinforcing agent (D) may include a core-shell type copolymer, a linear olefin-based copolymer, or a combination thereof. The core-shell type copolymer may include an unsaturated monomer comprising an acrylic-based monomer, an aromatic vinyl monomer, an unsaturated nitrile monomer, or a combination thereof, grafted on a rubbery polymer obtained by polymerizing a monomer comprising a diene-based monomer, an acrylic-based monomer, a silicon-based monomer, or a combination thereof. The linear olefin-based copolymer may be a copolymer of an olefin-based monomer and an acrylic-based monomer.

The polyester/polycarbonate alloy resin composition may further include one or more additives such as but not limited to an antibacterial agent, a heat stabilizer, an antioxidant, a release agent, a light stabilizer, a compatibilizer, an inorganic material additive, a surfactant, a coupling agent, a plasticizer, an admixture, a colorant, a lubricant, an antistatic agent, a flame proofing agent, a weather-resistance agent, an ultraviolet (UV) blocking agent, a filler, a nucleating agent, an adhesion aid, an adhesive, or a combination thereof.

According to another embodiment, a molded product made using the polyester/polycarbonate alloy resin composition is provided.

Hereinafter, further embodiments will be described in detail.

The polyester/polycarbonate alloy resin composition according to one embodiment may be used for a variety of articles that are not painted due to excellent impact resistance, heat resistance, and external appearance of an injection molded product, for example molded external materials of automobiles.

### DETAILED DESCRIPTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements.

In the present specification, when a specific description is not provided, “aromatic or alicyclic (meth)acrylate” refers to “aromatic or alicyclic acrylate” and “aromatic or alicyclic methacrylate”. Additionally, “(meth)acrylate” refers to “acrylate” and “methacrylate”. Additionally, “(meth)acrylic acid alkyl ester” refers to “acrylic acid alkyl ester” and “methacrylic acid alkyl ester”, and “(meth)acrylic acid ester” refers to “acrylic acid ester” and “methacrylic acid ester”.

The polyester/polycarbonate alloy resin composition according to one embodiment can include (A) about 100 parts by weight of a base resin including (A-1) about 40 to about 95 wt % of a polyester resin; and (A-2) about 5 to about 60 wt % of a polycarbonate resin; (B) about 0.1 to about 20 parts by weight of a copolymer of a vinyl cyanide compound and an aromatic vinyl compound; and (C) about 0.1 to about 10 parts by weight of a modified acrylic-based polymer, wherein the amounts of (B) and (C) are based on about 100 parts by weight of the base resin.

The polyester/polycarbonate alloy resin composition may further include (D) about 1 to about 30 parts by weight of an impact-reinforcing agent, based on about 100 parts by weight of the base resin.

Exemplary components included in the polyester/polycarbonate alloy resin composition according to embodiments will hereinafter be described in detail.

(A) Base Resin

(A-1) Polyester Resin

The polyester resin according to one embodiment is an aromatic polyester resin and may be prepared by condensation polymerization, such as melt polymerization of terephthalic acid or terephthalic acid alkyl ester and a C2 to C10 glycol component. As used herein, the alkyl may be C1 to C10 alkyl.

The polyester resin (A-1) may have an intrinsic viscosity [η] of about 0.35 to about 1.5 dl/g. Intrinsic viscosity can be measured under conditions suitable for a particular resin, which conditions are known and understood by the skilled artisan without undue experimentation. Specifically, the intrinsic viscosity may be measured according to ASTM D2857 method.

For example, as discussed herein, the intrinsic viscosity of polybutylene terephthalate resin can be measured in o-chloro phenol at 25° C., and the intrinsic viscosity of polyethylene terephthalate resin can be measured in phenol and tetrachloroethane mixed at a weight ratio of about 50:50 at 30° C. Details for measuring intrinsic viscosity for other polyester resins are not provided herein as such details are well known in the art and can be readily determined by the skilled artisan without undue experimentation.

When the intrinsic viscosity of the polyester resin (A-1) falls in the above range, mechanical strength and molding properties may be improved.

Specific examples of the aromatic polyester resin may include without limitation a polyethylene terephthalate resin, a polytrimethylene terephthalate resin, a polybutylene terephthalate resin, a polyhexamethylene terephthalate resin, a polycyclohexane dimethylene terephthalate resin, a polyester resin modified into an amorphous resin by mixing the foregoing resins with another monomer, and the like, and combinations thereof. In exemplary embodiments, the aromatic polyester resin may include a polyethylene terephthalate resin, a polytrimethylene terephthalate resin, a polybutylene terephthalate resin, an amorphous polyethylene terephthalate resin, or a combination thereof, for example a polybutylene terephthalate resin, a polyethylene terephthalate resin, or a combination thereof.

The polybutylene terephthalate resin is a condensation-polymerized polymer obtained through a direct ester reaction or an ester exchange reaction of a 1,4-butanediol monomer and terephthalic acid or dimethyl terephthalate monomer.

In exemplary embodiments, to increase impact strength of the polybutylene terephthalate resin, the polybutylene terephthalate resin may be copolymerized with polytetramethylene glycol (PTMG), polyethylene glycol (PEG), polypropylene glycol (PPG), low molecular-weight aliphatic polyester, or aliphatic polyamide, or may be used in the form of a modified polybutylene terephthalate resin obtained by blending with an impact improvement component.

The polybutylene terephthalate resin may have an intrinsic viscosity [η] of about 0.35 to about 1.5 dl/g, for example, about 0.5 to about 1.3 dl/g, when measured with o-chloro phenol at 25° C. When the intrinsic viscosity of the polybutylene terephthalate resin falls in the above range, mechanical strength and molding properties can be excellent.

The polyethylene terephthalate resin is a linear resin prepared by polycondensation of terephthalic acid and ethylene glycol. The polyethylene terephthalate resin can includes polyethylene terephthalate homopolymer, polyethylene terephthalate copolymer, or a combination thereof.

Also, the polyethylene terephthalate copolymer may be an amorphous polyethylene terephthalate copolymer using 1,4-cyclohexane dimethanol (CHDM) as a copolymerization component, or it may be a copolymer in which a part of an ethylene glycol component is substituted with 1,4-cyclohexane dimethanol. In exemplary embodiments, the amount of the 1,4-cyclohexane dimethanol in the ethylene glycol component may range from about 3 to about 48 mol %, for example about 5 to about 20 mol %. When the amount of the 1,4-cyclohexane dimethanol falls in the above range, improvement in the surface smoothness and heat resistance may be expected.

The polyethylene terephthalate resin may have an intrinsic viscosity [η] of about 0.5 to about 1 dl/g when it is prepared by dissolving a polyethylene terephthalate resin in an amount about of 0.5 wt % in a viscous solvent prepared by mixing phenol and tetrachloroethane at a weight ratio of about 50:50 and measuring the intrinsic viscosity [η] at 30° C. When the intrinsic viscosity of the polyethylene terephthalate resin falls in the above range, the mechanical strength and molding properties may be excellent.

The base resin (A) may include the polyester resin (A-1) in an amount of about 40 to about 95 wt %, for example about 60 to about 90 wt %, and as another example about 60 to about 70 wt %, based on the total amount of a base resin including the polyester resin and the polycarbonate resin. In some embodiments, the mixed resin may include the polyester resin in an amount of about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt %. Further, according to some embodiments of the present invention, the amount of the polyester resin can be in a range from about any of the foregoing amounts to about any other of the foregoing amounts.

When the base resin includes the polyester resin in an amount within the above range, heat resistance and impact resistance may be excellent and chemical resistance and weather resistance may be improved.

(A-2) Polycarbonate Resin

The polycarbonate resin according to one embodiment may be prepared by reacting one or more diphenols of the following Formula 1 with phosgene, halogen formate, carbonate, or a combination thereof.

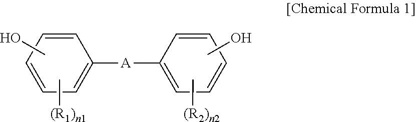

In Chemical Formula 1,

A is a linking group comprising a single bond, substituted or unsubstituted C1 to C5 alkylene, substituted or unsubstituted C2 to C5 alkylidene, substituted or unsubstituted C1 to C5 alkenylene, substituted or unsubstituted C5 and C6 cycloalkylene, substituted or unsubstituted C5 to C10 cycloalkylidene, substituted or unsubstituted C5 and C6 cycloalkenylene, —CO—, —S—, or —SO₂—,

each R₁ and R₂ can be the same or different and is each independently substituted or unsubstituted C1 to C30 alkyl or substituted or unsubstituted C6 to C30 aryl, and

n₁ and n₂ the same or different and are each independently an integer ranging from 0 to 4.

As used herein, unless otherwise defined, the term “substituted” refers to substitution of hydrogen with a substituent comprising halogen, C1 to C30 alkyl, C1 to C30 haloalkyl, C6 to C30 aryl, C1 to C20 alkoxy, or a combination thereof.

The diphenols represented by the above Chemical Formula 1 may be used singly or in combinations to constitute repeating units of the polycarbonate resin. Specific examples of the diphenols may include without limitation hydroquinone, resorcinol, 4,4′-dihydroxydiphenyl, 2,2-bis (4-hydroxyphenyl)propane (referred to as ‘bisphenol-A’), 2,4-bis (4-hydroxyphenyl)-2-methylbutane, 1,1-bis(4-hydroxyphenyl)cyclohexane, 2,2-bis(3-chloro-4-hydroxyphenyl)propane, 2,2-bis (3,5-dichloro-4-hydroxyphenyl)propane, and the like, and combinations thereof. In exemplary embodiments, the diphenol may include 2,2-bis (4-hydroxyphenyl)propane, 2,2-bis(3,5-dichloro-4-hydroxyphenyl)propane, 1,1-bis(4-hydroxyphenyl)cyclohexane, or a combination thereof, for example, 2,2-bis(4-hydroxyphenyl)propane.

The polycarbonate resin may have a weight average molecular weight ranging from about 10,000 to about 200,000 g/mol, for example about 20,000 to about 50,000 g/mol. When the polycarbonate resin has a weight average molecular weight within the above range, properties such as excellent impact strength and excellent processibility due to appropriate fluidity may be obtained.

The polycarbonate resin may be a mixture of copolymers prepared from two or more different diphenols.

Examples of the polycarbonate resin include without limitation linear polycarbonate resins, branched polycarbonate resins, polyester carbonate copolymer resins, and the like, and combinations thereof.

The linear polycarbonate resin may include a bisphenol-A based polycarbonate resin. The branched polycarbonate resin may include one produced by reacting a multi-functional aromatic compound such as trimellitic anhydride, trimellitic acid, and the like with one or more diphenols and a carbonate. The multi-functional aromatic compound may be included in an amount of about 0.05 to about 2 mol % based on the total weight of the branched polycarbonate resin. The polyester carbonate copolymer resin may be prepared by reacting a difunctional carboxylic acid with one or more diphenols and carbonate. The carbonate may include a diaryl carbonate such as diphenyl carbonate, and ethylene carbonate.

The mixed resin (A-1) may include the polycarbonate resin in an amount of about 5 to about 60 wt %, for example about 10 to about 40 wt %, and as another example about 30 to about 40 wt %, based on the total amount of a base resin including a polyester resin and a polycarbonate resin. In some embodiments, the mixed resin may include the polycarbonate resin in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt %. Further, according to some embodiments of the present invention, the amount of the polycarbonate resin can be in a range from about any of the foregoing amounts to about any other of the foregoing amounts.

When the mixed resin includes the polycarbonate resin in an amount within the above range, heat resistance and impact resistance may be excellent and chemical resistance and weather resistance may be improved.

(B) Copolymer of Vinyl Cyanide Compound and Aromatic Vinyl Compound

The copolymer of a vinyl cyanide compound and an aromatic vinyl compound according to one embodiment may include a copolymer with a weight average molecular weight of about 70,000 to about 400,000 g/mol.

Examples of the vinyl cyanide compound may include without limitation acrylonitrile, methacrylonitrile, methacrylic acid alkyl esters, acrylic acid alkyl esters, maleic anhydride, alkyl and/or phenyl N-substituted maleimide, and the like, and combinations thereof, wherein the alkyl is C1 to C8 alkyl.

Examples of the aromatic vinyl compound may include without limitation styrene, α-methylstyrene, halogen and/or alkyl substituted styrene, methacrylic acid alkyl esters, acrylic acid alkyl esters, and the like, and combinations thereof, wherein the alkyl is C1 to C8 alkyl.

The copolymer of a vinyl cyanide compound and an aromatic vinyl compound may include a repeating unit derived from the vinyl cyanide compound in an amount of about 1 to about 30 wt %, for example about 1 to about 25 wt %, and as another example about 10 to about 25 wt %, based on the total weight of the copolymer of a vinyl cyanide compound and an aromatic vinyl compound. In some embodiments, the copolymer of a vinyl cyanide compound and an aromatic vinyl compound may include a repeating unit derived from the vinyl cyanide compound in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the amount of the repeating unit derived from the vinyl cyanide compound can be in a range from about any of the foregoing amounts to about any other of the foregoing amounts.

When the repeating unit derived from the vinyl cyanide compound is included in an amount within the above range, the polycarbonate resin can be distributed with a stable phase and the impact resistance may be improved.

The polyester/polycarbonate alloy resin composition may include the copolymer of a vinyl cyanide compound and an aromatic vinyl compound in an amount of about 0.1 to about 20 parts by weight, for example about 0.5 to about 10 parts by weight, based on about 100 parts by weight of a base resin including polyester resin and polycarbonate resin. In some embodiments, the polyester/polycarbonate alloy resin composition may include the copolymer of a vinyl cyanide compound and an aromatic vinyl compound in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, or 20 parts by weight. Further, according to some embodiments of the present invention, the amount of the copolymer of a vinyl cyanide compound and an aromatic vinyl compound can be in a range from about any of the foregoing amounts to about any other of the foregoing amounts.

When the polyester/polycarbonate alloy resin composition includes the copolymer of a vinyl cyanide compound and an aromatic vinyl compound in an amount within the above range, compatibility can be excellent and impact resistance and heat resistance can be improved.

(C) Modified Acrylic-Based Polymer

The modified acrylic-based polymer according to one embodiment may be prepared by polymerizing an aromatic acrylic-based compound, an alicyclic acrylic-based compound, or a combination thereof, with a compound that may be copolymerized with the aromatic and/or alicyclic acrylic-based compound.

The aromatic and/or alicyclic acrylic-based compound may be an acrylic-based compound including an aromatic and/or alicyclic substituent such as but not limited to a cyclohexyl group, an ethylphenoxy group, a phenyl group, and the like, and combinations thereof.

The acrylic-based compound may be a (meth)acrylate compound, for example, the acrylic-based compound may be a methacrylate compound.

The aromatic and/or alicyclic acrylic-based compound may include without limitation a monomer comprising cyclohexyl(meth)acrylate, ethylphenoxy(meth)acrylate, 2-ethylthiophenyl(meth)acrylate, 2-ethylaminophenyl(meth)acrylate, phenyl(meth)acrylate, benzyl(meth)acrylate, 2-phenylethyl(meth)acrylate, 3-phenylpropyl(meth)acrylate, 4-phenylbutyl(meth)acrylate, 2-2-methylphenylethyl(meth)acrylate, 2-3-methylphenylethyl(meth)acrylate, 2-4-methyl phenylethyl (meth)acrylate, 2-(4-propylphenyl)ethyl(meth)acrylate, 2-(4-(1-methylethyl)phenyl)ethyl(meth)acrylate, 2-(4-methoxyphenyl)ethyl(meth)acrylate, 2-(4-cyclohexylphenyl)ethyl(meth)acrylate, 2-(2-chlorophenyl)ethyl(meth)acrylate, 2-(3-chlorophenyl)ethyl(meth)acrylate, 2-(4-chlorophenyl)ethyl(meth)acrylate, 2-(4-bromophenyl)ethyl(meth)acrylate, 2-(3-phenylphenyl)ethyl(meth)acrylate, 2-(4-benzylphenyl)ethyl(meth)acrylate, and the like, and combinations thereof. In exemplary embodiments, examples of the monomer can include without limitation cyclohexyl(meth)acrylate, ethylphenoxy(meth)acrylate, phenyl(meth)acrylate, and the like, and combinations thereof.

The compound that may be polymerized with the aromatic and/or alicyclic acrylic-based compound is a monofunctional unsaturated compound. Specific examples of the compound that may be polymerized with the aromatic and/or alicyclic acrylic-based compound may include without limitation: alkyl methacrylates such as methyl methacrylate, ethyl methacrylate, propyl methacrylate, butyl methacrylate, and the like; alkyl acrylates such as methyl acrylate, ethyl acrylate, propyl acrylate, butyl acrylate, 2-ethylhexyl acrylate, and the like; unsaturated carboxylic acids such as acrylic acid, methacrylic acid, and the like; acid anhydrides such as maleic anhydride, and the like; acrylates including a hydroxyl group such as 2-hydroxyethyl acrylate, 2-hydroxypropyl acrylate, monoglycerol acrylate, and the like; amides such as acrylamide, methacrylamide, and the like; nitriles such as acrylonitrile, methacrylonitrile, and the like; allylglycidylethers such as glycidylmethacrylate; and styrenic monomers such as styrene, α-methylstyrene, and the like; and combinations thereof.

In exemplary embodiments, the modified acrylic-based polymer may include about 20 to about 100 wt %, for example about 20 to about 99.9 wt %, of the aromatic and/or alicyclic acrylic-based compound and about 0 to about 80 wt %, for example about 0.1 to about 80 wt %, of a compound that may be polymerized with the aromatic and/or alicyclic acrylic-based compound.

In some embodiments, the modified acrylic-based polymer may include the aromatic and/or alicyclic acrylic-based compound in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 wt %. Further, according to some embodiments of the present invention, the amount of the aromatic and/or alicyclic acrylic-based compound can be in a range from about any of the foregoing amounts to about any other of the foregoing amounts.

In some embodiments, the modified acrylic-based polymer may include the compound that may be polymerized with the aromatic and/or alicyclic acrylic-based compound in an amount of 0 wt % (that is, the compound that may be polymerized with the aromatic and/or alicyclic acrylic-based compound is not present), or about 0 (the compound that may be polymerized with the aromatic and/or alicyclic acrylic-based compound is present in an amount greater than 0 wt %), 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %. Further, according to some embodiments of the present invention, the amount of the compound that may be polymerized with the aromatic and/or alicyclic acrylic-based compound can be in a range from about any of the foregoing amounts to about any other of the foregoing amounts.

When the modified acrylic-based polymer includes the aromatic and/or alicyclic acrylic-based compound in an amount of about 20 wt % or more, the average refractive index of the polymerized modified acrylic-based polymer may be maintained at about 1.495 or higher.

In exemplary embodiments, the modified acrylic-based polymer may include a polymer of methylmethacrylate and phenylmethacrylate.

The modified acrylic-based polymer may be polymerized by bulk polymerization, emulsion polymerization, or suspension polymerization.

The modified acrylic-based polymer prepared according to the above-described method can have a higher refractive index than conventional acrylic-based polymers. In other words, the modified acrylic-based polymer prepared according to one embodiment may have the same refractive index as the polycarbonate resin. In exemplary embodiments, the modified acrylic-based polymer may have a refractive index of about 1.495 to about 1.59. When the modified acrylic-based polymer has an increased refractive index, that is, when the modified acrylic-based polymer has a refractive index within the above range, compatibility and transparency can be improved so that the modified acrylic-based polymer is mixed well when it is blended with the polycarbonate resin. Accordingly, the scratch resistance of the polycarbonate resin can be improved and a resin having a high colorizing property and high transparency may be prepared.

The modified acrylic-based polymer may be a homopolymer prepared using one kind of acrylic-based monomer, or a copolymer using two or more kinds of acrylic-based monomers, or a mixture thereof.

The modified acrylic-based polymer may have a weight average molecular weight of about 5,000 to about 200,000 g/mol. When the modified acrylic-based polymer has a weight average molecular weight in an amount of the above range, carbonization or decomposition may not occur during compounding, and it is possible to acquire excellent compatibility with the polycarbonate resin and excellent transparency.

The polyester/polycarbonate alloy resin composition can include the modified acrylic-based polymer in an amount of about 0.1 to about 10 parts by weight, for example about 0.5 to about 5 parts by weight, based on about 100 parts by weight of a base resin including a polyester resin and a polycarbonate resin. In some embodiments, the polyester/polycarbonate alloy resin composition can include the modified acrylic-based polymer in an amount of about 0.1, 0.2, 0.3, 0.4, 0.5, 0.6, 0.7, 0.8, 0.9, 1, 2, 3, 4, 5, 6, 7, 8, 9, or 10 parts by weight. Further, according to some embodiments of the present invention, the amount of the modified acrylic-based polymer can be in a range from about any of the foregoing amounts to about any other of the foregoing amounts.

When the polyester/polycarbonate alloy resin composition includes the modified acrylic-based polymer in an amount within the above range, compatibility, impact resistance and scratch resistance can be improved.

(D) Impact-Reinforcing Agent

The polyester/polycarbonate alloy resin composition according to one embodiment may further include (D) an impact-reinforcing agent.

The impact-reinforcing agent may be a core-shell type copolymer, a linear olefin-based copolymer, or a combination thereof.

The core-shell type copolymer has a core-shell structure where unsaturated monomers are grafted on a rubber core to form a hard shell. Examples of the unsaturated monomers may include without limitation acrylic-based monomers, aromatic vinyl monomers, unsaturated nitrile monomers, and the like, and combinations thereof. The rubber core can include a rubbery polymer obtained by polymerizing a monomer such as but not limited to a diene-based monomer, an acrylic-based monomer, a silicon-based monomer, or a combination thereof.

Examples of the diene-based monomer may include without limitation butadiene, isoprene, and the like, and combinations thereof. In exemplary embodiments, butadiene may be used.

Examples of the acrylic-based monomer may include without limitation methylacrylate, ethylacrylate, n-propylacrylate, n-butylacrylate, 2-ethylhexylacrylate, hexylmethacrylate, 2-ethyl hexyl metacrylate, and the like, and combinations thereof. A curing agent such as ethylene glycol dimethacrylate, propylene glycol dimethacrylate, 1,3-butylene glycol dimethacrylate, 1,4-butylene glycol dimethacrylate, allylmethacrylate, triallylcyanurate, and the like, and combinations thereof may be used.

The silicon-based monomer may be obtained from a cyclosiloxane. Examples of the silicon-based monomer may include without limitation hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrasiloxane, octaphenylcyclotetrasiloxane, and the like, and combinations thereof. A curing agent such as trimethoxymethylsilane, triethoxyphenylsilane, tetramethoxysilane, tetraethoxysilane, and the like, and combinations thereof may be used.

The rubbery polymer may have a rubber average particle diameter of about 0.4 to about 1 μm to improve balance of impact resistance and colorfastness.

In exemplary embodiments, the impact-reinforcing agent can include the rubbery polymer in an amount of about 20 to about 80 wt %, based on the total weight of the impact-reinforcing agent. When the impact-reinforcing agent includes the rubbery polymer in an amount within the above range, improvement in impact reinforcement effect and heat resistance may be maximized and fluidity can be significantly improved.

Examples of the acrylic-based monomer of the unsaturated monomer may include without limitation (meth)acrylic acid alkyl esters, (meth)acrylic acid esters, and the like, and combinations thereof. As used herein, the alkyl may be a C1 to C10 alkyl. Specific examples of the (meth)acrylic acid alkyl esters include without limitation methyl(meth)acrylate, ethyl(meth)acrylate, propyl(meth)acrylate, butyl(meth)acrylate, and the like, and combinations thereof. In exemplary embodiments, methyl(meth)acrylate may be used.

Examples of the aromatic vinyl monomer of the unsaturated monomer may include without limitation styrene, C1-C10 alkyl-substituted styrenes, halogen-substituted styrenes, and the like, and combinations thereof. Examples of the alkyl-substituted styrene may include without limitation o-ethyl styrene, m-ethyl styrene, p-ethyl styrene, alpha-methyl styrene, and the like, and combinations thereof.

Examples of the unsaturated nitrile monomer of the unsaturated monomer may include without limitation acrylonitrile, methacrylonitrile, ethacrylonitrile, and the like, and combinations thereof.

The linear olefin-based copolymer may include a copolymer of an olefin-based monomer and an acrylic-based monomer.

Examples of the olefin-based monomer of the linear olefin-based copolymer may include without limitation ethylene, propylene, isopropylene, butylene, isobutylene, and the like, and combinations thereof.

Examples of the acrylic-based monomer of the linear olefin-based copolymer may include without limitation (meth)acrylic acid alkyl esters, (meth)acrylic acid esters, and the like, and combinations thereof. As used herein, the alkyl may be a C1 to C10 alkyl. Examples of the (meth)acrylic acid alkyl ester may include without limitation methyl(meth)acrylate, ethyl(meth)acrylate, propyl(meth)acrylate, butyl(meth)acrylate, and the like, and combinations there. In exemplary embodiments, methyl(meth)acrylate may be used.

The linear olefin-based copolymer may be prepared by using a Ziegler-Natta catalyst, which is a common olefin polymerization catalyst and may be prepared to have a more selective structure by using a metallocene-based catalyst.

The impact-reinforcing agent according to one embodiment may be an impact-reinforcing agent without a functional group in order to prevent color change during injection molding and to improve injection appearance.

When the polyester/polycarbonate alloy resin composition according to one embodiment includes the impact-reinforcing agent, the impact-reinforcing agent may be included in an amount of about 1 to about 30 parts by weight, for example about 5 to about 15 parts by weight, based on about 100 parts by weight of the base resin including the polyester resin and polycarbonate resin.

In some embodiments, the polyester/polycarbonate alloy resin composition may include the impact-reinforcing agent in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the impact-reinforcing agent can be in a range from about any of the foregoing amounts to about any other of the foregoing amounts.

When the impact-reinforcing agent is included in an amount within the above range, the impact reinforcement effect and increase in heat resistance may be maximized, and the fluidity can also be improved, resulting in improved injection molding properties.

(E) Other Additive(s)

The polyester/polycarbonate alloy resin composition according to one embodiment may further include one or more additives. Examples of the additives include without limitation antibacterial agents, heat stabilizers, antioxidants, release agents, light stabilizers, compatibilizers, inorganic material additives, surfactants, coupling agents, plasticizers, admixtures, colorants, lubricants, antistatic agents, flame proofing agents, weather-resistance agents, ultraviolet (UV) blocking agents, fillers, nucleating agents, adhesion aids, adhesives, and the like, and combinations thereof.

Examples of the antioxidant may include without limitation phenol-based antioxidants, phosphite-based antioxidants, thioether-based antioxidants, amine-based antioxidants, and the like, and combinations thereof.

Examples of the release agent may include without limitation fluorine-included polymers, silicone oils, metal salts of stearylic acid, metal salts of montanic acid, montanic acid ester waxes, polyethylene waxes, and the like, and combinations thereof.

Examples of the weather-resistance agent may include without limitation benzophenone-based weather-resistance agents, amine-based weather-resistance agents, and the like, and combinations thereof.

Examples of the colorant may include without limitation dyes, pigments, and the like, and combinations thereof.

Examples of the ultraviolet (UV) blocking agent may include without limitation titanium oxide (TiO₂), carbon black, and the like, and combinations thereof.

Examples of the filler may include without limitation glass fiber, carbon fiber, silica, mica, alumina, clay, calcium carbonate, calcium sulfate, glass beads, and the like, and combinations thereof. When the filler is added, the mechanical strength and heat resistance may be improved.

Examples of the nucleating agent may include without limitation talc, clay, and the like, and combinations thereof.

The additive may be included in an amount of about 0.1 to about 30 parts by weight based on about 100 parts by weight of the base resin including polyester resin and polycarbonate resin. When the additive is included in an amount within the above range, the expected effects of the respective additives may be obtained, and excellent mechanical properties and improved surface appearance may be obtained.

The polyester/polycarbonate alloy resin composition according to one embodiment may be prepared using conventional methods widely known to those skilled in the art. For example, the components and optional additive(s) may be mixed, melt mixed in an extruder, and extruded in the form of pellets.

According to another embodiment, a molded product can be fabricated by molding the polyester/polycarbonate alloy resin composition described above. The polyester/polycarbonate alloy resin composition can provide excellent injection molding appearance and impact resistance, and can be used for a variety of articles, including articles that are not painted, for example molded external materials of automobiles.

The following examples illustrate the present invention in more detail. However, they are exemplary embodiments of the present invention and are not limiting.

### EXAMPLE

The polyester/polycarbonate alloy resin composition according to one embodiment included the following components.

A Base Resin

A-1 Polyester Resin

(A-1-1) DHK 011 produced by Shinkong having an intrinsic viscosity[η] of 1.2 dl/g is used as a polybutylene terephthalate resin.

(A-1-2) SKYPET 1100 produced by SK Chemicals having an intrinsic viscosity[η] of 0.77 dl/g is used as a polyethylene terephthalate resin.

(A-2) Polycarbonate Resin

CALIBRE 200-3 produced by LG-DOW having a weight average molecular weight of 35,000 g/mol is used.

(B) Copolymer of Vinyl Cyanide Compound and Aromatic Vinyl Compound

(B-1) SAN (styrene-acrylonitrile) resin having an acrylonitrile amount of 24 wt % and a weight average molecular weight of 90,000 g/mol is used.

(B-2) SAN resin having an acrylonitrile amount of 40 wt % and a weight average molecular weight of 120,000 g/mol is used in the Comparative Examples.

(C) Modified Acrylic-Based Polymer

A linear polymer having a weight average molecular weight of 120,000 g/mol is used. The polymer is prepared by polymerizing 50 wt % of methylmethacrylate and 50 wt % of phenylmethacrylate using a conventional suspension polymerization method.

(D) Impact-Reinforcing Agent

Metablen C223-A produced by MRC is used.

### Examples 1 to 3 and Comparative Examples 1 to 5

The above components in the amounts shown in the following Table 1 are extruded in a conventional bi-axial extruder at a feed rate of 60 kg/hr, at a screw speed (rpm) of 250, at a temperature of 250° C., in a screw configuration of 45φ Regular, L/D=36, into the form of pellets.

TABLE 1

| | | | | | | Comparative | | | | |
|---|---|---|---|---|---|---|---|---|---|---|
| | | | Example | | | Example | | | | |
| | | | 1 | 2 | 3 | 1 | 2 | 3 | 4 | 5 |
| (A) Base resin | (A-1) Polyester | (A-1-1) | 60 | — | — | 60 | 65 | 60 | 60 | 60 |
| | resin (wt %) | (A-1-2) | — | 62 | 70 | — | — | — | — | — |

| | | | | | | | | |
|---|---|---|---|---|---|---|---|---|
| (A-2) Polycarbonate | 40 | 38 | 30 | 40 | 35 | 40 | 40 | 40 |
| resin (wt %) | | | | | | | | |

| | | | | | | | | | |
|---|---|---|---|---|---|---|---|---|---|
| (B) Copolymer of a vinyl cyanide | B-1 | 0.5 | 3 | 10 | — | 22 | — | 0.5 | 0.5 |
| compound and an aromatic vinyl | B-2 | — | — | — | — | — | 2 | — | — |
| compound (parts by weight*) | | | | | | | | | |

| | | | | | | | | |
|---|---|---|---|---|---|---|---|---|
| (C) Modified acrylic-based polymer (parts by weight*) | 0.5 | 1 | 3 | — | — | — | — | 15 |
| (D) Impact-reinforcing agent (parts by weight*) | 8 | 8 | 8 | 8 | 8 | 8 | 8 | 8 |

*Part(s) by weight denotes a content unit represented based on 100 parts by weight of the base resin.

Pellets fabricated according to Examples 1 to 3 and Comparative Examples 1 to 5 are dried at 100° C. for 3 hours or more, and shot out by using a 10-oz injection molder at a molding temperature of 250 to 270° C. and a metal-patterning temperature of 60 to 80° C. to thereby produce specimens. The physical properties of the specimens are measured by the following methods, and the results are presented in the following Table 2.

(1) Impact strength: Impact strength (¼″) is measured according to ASTM D256. The average value and standard deviation of 5 specimens are as shown below.

(2) Fluidity: Fluidity (260° C., 5 kg) is measured according to ASTM D1238 and presented as melt index (MI).

(3) Thermal distortion temperature: Heat resistance (18.5 kg) is measured according to ASTM D648.

(4) Gloss (20°): Gloss is measured according to ASTM D523

TABLE 2

| | Example | | | Comparative Example | | | | |
|---|---|---|---|---|---|---|---|---|
| | 1 | 2 | 3 | 1 | 2 | 3 | 4 | 5 |
| Impact strength average value (kgf · cm/cm) | 50 | 48 | 46 | 35 | 35 | 30 | 42 | 10 |
| Impact strength standard deviation | 0.9 | 0.7 | 0.5 | 11.2 | 0.8 | 2.6 | 5.2 | 3.0 |
| Fluidity (g/10 min) | 33 | 34 | 37 | 40 | 46 | 34 | 36 | 50 |
| Thermal distortion (° C.) temperature | 94 | 100 | 96 | 83 | 78 | 80 | 90 | 70 |
| Gloss (20° C.) | 83.2 | 84 | 83 | 80.7 | 82.3 | 81.5 | 84 | 82 |

It may be seen from Tables 1 and 2 that Examples 1 to 3 show excellent impact resistance and small deviation of impact resistance between specimens, excellent heat resistance and external appearance of an injection molded product, and excellent gloss, compared with Comparative Examples 1 to 5 where the modified acrylic-based polymer or a copolymer of a vinyl cyanide compound and an aromatic vinyl compound is not used, or used in an amount outside of the ranges of the invention. Thus, the pellets manufactured according to Examples 1 to 3 may be used without a painting process.

For example, in Comparative Example 1, which did not include the copolymer of a vinyl cyanide compound and an aromatic vinyl compound and the modified acrylic-based polymer, the deviation of impact resistance between specimens increased and the heat resistance deteriorated. In Comparative Example 2, which included the copolymer of a vinyl cyanide compound and an aromatic vinyl compound in an amount outside of the range of the present invention and did not include a modified acrylic-based polymer, and Comparative Example 3, which included a copolymer of a vinyl cyanide compound and an aromatic vinyl compound containing an excessive amount of vinyl cyanide compound and also did not include a modified acrylic-based polymer, the impact resistance and the heat resistance deteriorated. In Comparative Example 4, which did not include the modified acrylic-based polymer, the deviation of impact resistance between specimens is great, just as in Comparative Example 1. In Comparative Example 5, in which the modified acrylic-based polymer is used in an amount outside of the range of the present invention, the impact resistance is significantly deteriorated.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A polyester/polycarbonate alloy resin composition, comprising:
(A) about 100 parts by weight of a base resin including (A-1) about 40 to about 95 wt % of a polyester resin; and (A-2) about 5 to about 60 wt % of a polycarbonate resin;
(B) about 0.1 to about 20 parts by weight of a copolymer of a vinyl cyanide compound and an aromatic vinyl compound, based on about 100 parts by weight of the base resin; and
(C) about 0.1 to about 10 parts by weight of a modified acryl-based polymer, based on about 100 parts by weight of the base resin.

2. The polyester/polycarbonate alloy resin composition of claim 1, wherein the base resin (A) comprises about 60 to about 90 wt % of the polyester resin (A-1) and about 10 to about 40 wt % of the polycarbonate resin (A-2).

3. The polyester/polycarbonate alloy resin composition of claim 1, wherein the polyester resin (A-1) is a polybutylene terephthalate resin or a polyethylene terephthalate resin.

4. The polyester/polycarbonate alloy resin composition of claim 1, wherein the polyester resin (A-1) has an intrinsic viscosity [η] of about 0.35 to about 1.5 dl/g.

5. The polyester/polycarbonate alloy resin composition of claim 1, wherein the polycarbonate resin (A-2) is prepared by reacting one or more diphenols with phosgene, halogen formate, carbonate, or a combination thereof.

6. The polyester/polycarbonate alloy resin composition of claim 1, wherein the polycarbonate resin (A-2) has a weight average molecular weight of about 10,000 to about 200,000 g/mol.

7. The polyester/polycarbonate alloy resin composition of claim 1, wherein the copolymer of a vinyl cyanide compound and an aromatic vinyl compound (B) comprises about 1 to about 30 wt % of a repeating unit derived from the vinyl cyanide compound.

8. The polyester/polycarbonate alloy resin composition of claim 1, wherein the modified acrylic-based polymer (C) is a polymer of an aromatic acrylic-based compound, an alicyclic acrylic-based compound, or a combination thereof, and a compound that is polymerized with the aromatic acrylic-based compound, alicyclic acrylic-based compound, or combination thereof.

9. The polyester/polycarbonate alloy resin composition of claim 8, wherein the modified acryl-based polymer (C) includes the aromatic acrylic-based compound, alicyclic acrylic-based compound, or combination thereof in an amount of about 20 to about 99.9 wt % based on the total weight of the modified acrylic-based polymer (C).

10. The polyester/polycarbonate alloy resin composition of claim 8, wherein the aromatic acrylic-based compound, alicyclic acrylic-based compound or combination thereof is an acrylic-based compound including a substituent comprising a phenyl group, a cyclohexyl group, an ethylphenoxy group, or a combination thereof.

11. The polyester/polycarbonate alloy resin composition of claim 1, wherein the modified acrylic-based polymer (C) is a polymer of methylmethacrylate and phenylmethacrylate.

12. The polyester/polycarbonate alloy resin composition of claim 1, wherein the modified acrylic-based polymer(C) has the same refractive index as the polycarbonate resin (A-2).

13. The polyester/polycarbonate alloy resin composition of claim 1, wherein the polyester/polycarbonate alloy resin composition further comprises (D) about 1 to about 30 parts by weight of an impact-reinforcing agent, based on about 100 parts by weight of the base resin.

14. The polyester/polycarbonate alloy resin composition of claim 13, wherein the impact-reinforcing agent (D) is a core-shell type copolymer, a linear olefin-based copolymer, or a combination thereof.

15. The polyester/polycarbonate alloy resin composition of claim 14, wherein the core-shell type copolymer comprises an unsaturated monomer comprising an acrylic-based monomer, an aromatic vinyl monomer, an unsaturated nitrile monomer, or a combination thereof, grafted on a rubbery polymer obtained by polymerizing a monomer comprising a diene-based monomer, an acrylic-based monomer, a silicon-based monomer, or a combination thereof.

16. The polyester/polycarbonate alloy resin composition of claim 14, wherein the linear olefin-based copolymer is a copolymer of an olefin-based monomer and an acrylic-based monomer.

17. The polyester/polycarbonate alloy resin composition of claim 1, wherein the polyester/polycarbonate alloy resin composition further comprises an additive comprising an antibacterial agent, a heat stabilizer, an antioxidant, a release agent, a light stabilizer, a compatibilizer, an inorganic material additive, a surfactant, a coupling agent, a plasticizer, an admixture, a colorant, a lubricant, an antistatic agent, a flame proofing agent, a weather-resistance agent, an ultraviolet (UV) blocking agent, a filler, a nucleating agent, an adhesion aid, an adhesive, or a combination thereof.

18. A molded product made using the polyester/polycarbonate alloy resin composition according to claim 1.
